(19) United States
(12) Patent Application Publication
(10) Pub. No.: US 2010/0183785 A1
(43) Pub. Date: Jul. 22, 2010

(54) Method for doing business to retard bacterial, fungal, and viral contamination and mold growth in fruits

(76) Inventor: Zuniga Manuel, II, Pompano Beach, FL (US)

Correspondence Address: CHARLES E. BAXLEY, ESQUIRE, 90 JOHN STREET, SUITE 309, NEW YORK, NY, 10038, US

(21) Appl. No.: 12/321,609

(22) Filed: Jan. 21, 2009

(51) Int. Cl. A23B 7/144

(52) U.S. Cl. 426/316

(57) ABSTRACT

A method for doing business to retard bacterial, fungal, and viral contamination and mold growth in fruits. The method includes the steps of: filling a plastic liner bag with the fruits so as to form a filled liner bag, leaving a particular space in the filled liner bag; putting an anti-bacterial, fungal, and viral contamination and mold growth gas generating apparatus into the particular space in the filled liner bag; sealing the filled liner bag; generating an anti-bacterial, fungal, and viral contamination and mold growth gas by the anti-bacterial, fungal, and viral contamination and mold growth gas generating apparatus; circulating the anti-bacterial, fungal, and viral contamination and mold growth gas on its own volition throughout the filled liner bag; contacting the anti-bacterial, fungal, and viral contamination and mold growth gas with the fruits; retarding the bacterial, the fungal, and the viral contamination and the mold growth in the fruits; dissipating the anti-bacterial, fungal, and viral contamination and mold growth gas on its own volition after the anti-bacterial, fungal, and viral contamination and mold growth gas has contacted the fruits and retarded the bacterial, the fungal, and the viral contamination and the mold growth in the fruits; producing the fruits without the bacterial, the fungal, and the viral contamination and the mold growth; and removing the anti-bacterial, fungal, and viral contamination and mold growth gas generating apparatus with residual byproducts therein safely.

### 1. BACKGROUND OF THE INVENTION

A. Field of the Invention

The embodiments of the present invention relate to a method for preventing contamination of fruits, and more particularly, the embodiments of the present invention relate to a method for doing business to retard bacterial, fungal, and viral contamination and mold growth in fruits.

B. Description of the Prior Art

The use of gas for retarding, controlling, killing, or preventing microbiological contamination, e.g., bacteria, fungi, viruses, mold spores, algae, and protozoa; retarding, preventing, or controlling biochemical decomposition; controlling respiration, deodorizing, and/or retarding and preventing chemotaxis to name a few, is known. The gases include, but are not limited to, chlorine dioxide, sulfur dioxide, nitrogen dioxide, nitric oxide, nitrous oxide, carbon dioxide, hydrogen sulfide, hydrocyanic acid, and dichlorine monoxide. For example, the use and efficacy of chlorine dioxide is documented and discussed in various publications.¹ ¹G. D. Simpson et al., A Focus on Chlorine Dioxide, An Ideal Biocide http://clo2.com/readings/waste/corrosion.html: and K. K. Krause, DDS et al., The Effectiveness of Chlorine Dioxide in the Barrier System (visited Feb. 5, 2000) http://www.dentallogic.com/dentist/effects.htm.

In particular, chlorine dioxide has been found to be useful as a disinfectant, antiseptic, and sanitizer. It is used, e.g., to disinfect drinking water and various water supplies. In addition, chlorine dioxide finds use as a bleaching agent for flour, fats, and textiles. Chlorine dioxide also has shown great utility as an antiseptic for treating metal and plastic surfaces, as well as other substrates, such as countertops, meat processing and packaging equipment, and dental and medical instruments and devices.

One disadvantage of the prior art methods for generating chlorine dioxide gas generally, however, is that unsatisfactory levels of by-products or reactants remain as a residue. For example, in the case of chlorine dioxide gas, the byproduct chlorite leaves residues on food handling equipment and medical and dental surfaces. Human contact with these residues should be avoided, or substantially minimized, according to FDA and EPA regulations.

Another requirement in the food handling and related industries is the need for raw materials or ingredients that are safe to handle in the preparation of the disinfectant. The requirement is for the inclusion of reagents that are safe to use, and after generating chlorine dioxide, produce side products that are non-toxic and/or biodegradable.

Also, although it has great beneficial characteristics, chlorine dioxide cannot be transported commercially as a concentrated gas for its use, and instead, has been generated at the site where it is to be used.

Numerous innovations for contamination preventives have been provided in the prior art, which will be described below in chronological order to show advancement in the art, and which are incorporated herein by reference thereto. Even though these innovations may be suitable for the specific individual purposes to which they address, however, they differ from the embodiments of the present invention in that they do not teach a method for doing business to retard bacterial, fungal, and viral contamination and mold growth in fruits.

(1) U.S. Pat. No. 3,591,515 to Lovely.

U.S. Pat. No. 3,591,515 issued to Lovely on Jul. 6, 1971 in U.S. class 252 and subclass 187 teaches substantially dry pulverulent solid compositions including an amount of chlorine dioxide solutions, such as chlorine dioxide solutions stabilized with peroxy and percarbonate compounds, or a like solution, such as the alkaline chlorite solutions, adsorbed on a basic-reacting adsorbent, such as synthetic calcium silicate. These compositions yield gaseous chlorine dioxide upon acidification to a pH of less than about 6. Preferred acidifying agents include powered hydrated citric acid or dry acid reacting absorbents, such as silicates having an aqueous solution of an acidic compound, such as ferric chloride or sulfuric acid, absorbed thereon.

(2) U.S. Pat. No. 4,547,381 to Mason et al.

U.S. Pat. No. 4,547,381 issued to Mason et al. on Oct. 15, 1985 in U.S. class 426 and subclass 316 teaches a dry composition for the sustained, controlled production of gaseous chlorine dioxide, which includes: a dry, inert diluent; a metal chlorite selected from the group consisting of alkali metal chlorites and alkaline earth metal chlorites; and a dry agent capable of reacting with a metal chlorite in the dry state to produce chlorine dioxide. The agent is selected from the group consisting of dry oxidizing agents and dry acids. The composition is manufactured using solely dry constituents, thereby obviating an intensive drying step and resulting in substantial savings, as well as simplifying the manufacturing process. The compositions involve the controlled generation of chlorine dioxide for a sustained period of time.

(3) U.S. Pat. No. 5,650,446 to Wellinghoff et al.

U.S. Pat. No. 5,650,446 issued to Wellinghoff et al. on Jul. 22, 1997 in U.S. class 514 and subclass 772.3 teaches a composite for retarding bacterial, fungal, and viral contamination and mold growth, which includes a hydrophobic material containing an acid releasing agent and a hydrophilic material containing chlorite anions. The hydrophilic and hydrophobic materials are adjacent and substantially free of water, and the hydrophilic material is capable of releasing chlorine dioxide upon hydrolysis of the acid releasing agent.

(4) U.S. Pat. No. 5,705,092 to Wellinghoff et al.

U.S. Pat. No. 5,705,092 issued to Wellinghoff et al. on Jan. 6, 1998 in U.S. class 252 and subclass 187.21 teaches a multilayered composite for providing sustained release of chlorine dioxide, which includes a hydrophobic layer containing an acid releasing agent and a hydrophilic layer containing chlorite anions. The hydrophilic and hydrophobic layers are adjacent and substantially free of water, and the hydrophilic layer is capable of releasing chlorine dioxide upon hydrolysis of the acid releasing agent.

(5) U.S. Pat. No. 5,980,826 to Barenberg et al.

U.S. Pat. No. 5,980,826 issued to Barenberg et al. on Nov. 9, 1999 in U.S. class 422 and subclass 37 teaches a method of retarding bacterial, fungal, and viral contamination and growth of molds on the surface of a material and/or deodorizing the material by treating a surface with a composite that does not release chlorine dioxide in the absence of moisture, and exposing the treated surface to moisture to release chlorine dioxide from the composite into the atmosphere surrounding the material.

(6) U.S. Pat. No. 6,602,466 B2 to Hamilton et al.

U.S. Pat. No. 6,602,466 B2 issued to Hamilton et al. on Aug. 5, 2003 in U.S. class 422 and subclass 37 teaches an apparatus for delivery of a gas, e.g., carbon dioxide and/or chlorine dioxide, and methods of its use and manufacture. The apparatus includes an envelope, and a sachet within the envelope that contains a reactant that generates a gas in the presence of an initiating agent, e.g., water. In another embodiment, the apparatus includes: a barrier layer; a sachet layer disposed adjacent to the barrier layer; a reactant disposed between the barrier layer and the sachet layer, which generates a gas in the presence of an initiating agent; and an envelope layer disposed adjacent to the sachet layer.

### (7) United States Patent Application Publication Number US 2004/0081727 A1 to Kelly et al.

United States Patent Application Publication Number US 2004/0081727 A1 published to Kelly et al. on Apr. 29, 2004 in U.S. class 426 and subclass 118 teaches a gas-release packet including a flexible gas-permeable material enclosing or including one or more liquid-filled frangible sub-packets, and a gas-producing chemical composition that is activated when in contact with the liquid.

### (8) United States Patent Application Publication Number US 2006/0003057 A1 to Kelly et al.

United States Patent Application Publication Number US 2006/0003057 A1 published to Kelly et al. on Jan. 5, 2006 in U.S. class 426 and subclass 118 teaches a gas-release packet including a flexible gas-permeable material enclosing or including one or more liquid-filled frangible sub-packets, and a gas-producing chemical composition that is activated when in contact with the liquid.

It is apparent that numerous innovations for contamination preventives have been provided in the prior art, which are adapted to be used. Furthermore, even though these innovations may be suitable for the specific individual purposes to which they address, however, they would not be suitable for the purposes of the embodiments of the present invention as heretofore described, namely, a method for doing business to retard bacterial, fungal, and viral contamination and mold growth in fruits.

### 2. SUMMARY OF THE INVENTION

Thus, an object of the embodiments of the present invention is to provide a method for doing business to retard bacterial, fungal, and viral contamination and mold growth in fruits, which avoids the disadvantages of the prior art.

Briefly stated, another object of the embodiments of the present invention is to provide a method for doing business to retard bacterial, fungal, and viral contamination and mold growth in fruits. The method includes the steps of: filling a plastic liner bag with the fruits so as to form a filled liner bag, leaving a particular space in the filled liner bag; putting an anti-bacterial, fungal, and viral contamination and mold growth gas generating apparatus into the particular space in the filled liner bag; sealing the filled liner bag; generating an anti-bacterial, fungal, and viral contamination and mold growth gas by the anti-bacterial, fungal, and viral contamination and mold growth gas generating apparatus; circulating the anti-bacterial, fungal, and viral contamination and mold growth gas on its own volition throughout the filled liner bag; contacting the anti-bacterial, fungal, and viral contamination and mold growth gas with the fruits; retarding the bacterial, the fungal, and the viral contamination and the mold growth in the fruits; dissipating the anti-bacterial, fungal, and viral contamination and mold growth gas on its own volition after the anti-bacterial, fungal, and viral contamination and mold growth gas has contacted the fruits and retarded the bacterial, the fungal, and the viral contamination and the mold growth in the fruits; producing the fruits without the bacterial, the fungal, and the viral contamination and the mold growth; and removing the anti-bacterial, fungal, and viral contamination and mold growth gas generating apparatus with residual byproducts therein safely.

The novel features considered characteristic of the embodiments of the present invention are set forth in the appended claims. The embodiments of the present invention themselves, however, both as to their construction and their method of operation together with additional objects and advantages thereof will be best understood from the following description of the specific embodiments when read and understood in connection with the accompanying drawing.

### 3. BRIEF DESCRIPTION OF THE DRAWING

The figures of the drawing are briefly described as follows:

FIG. 1A-1H are a flowchart of the method of the embodiments of the present invention for doing business to retard bacterial, fungal, and viral contamination and mold growth in fruits.

### 4. LIST OF REFERENCE NUMERALS UTILIZED IN THE DRAWING

### A. General.

10 method of embodiments of present invention for doing business to retard bacterial, fungal, and viral contamination 12 and mold growth 14 in fruits 16
12 bacterial, fungal, and viral contamination
14 mold growth
16 fruits
   B. Method 10 for doing business to retard bacterial, fungal, and viral contamination 12 and mold growth 14 in fruits 16
18 crate
20 plastic liner bag
22 filled liner bag
24 particular space in filled liner bag 22
26 sodium chlorite
28 small inner sachet
30 inner sachet
32 sealed inner sachet
34 citric acid
36 large outer sachet
38 outer sachet
40 sealed outer sachet
42 breached inner sachet
44 chlorine dioxide gas
46 residual byproducts

### 5. DETAILED DESCRIPTION OF THE PREFERRED EMBODIMENTS

### A. General.

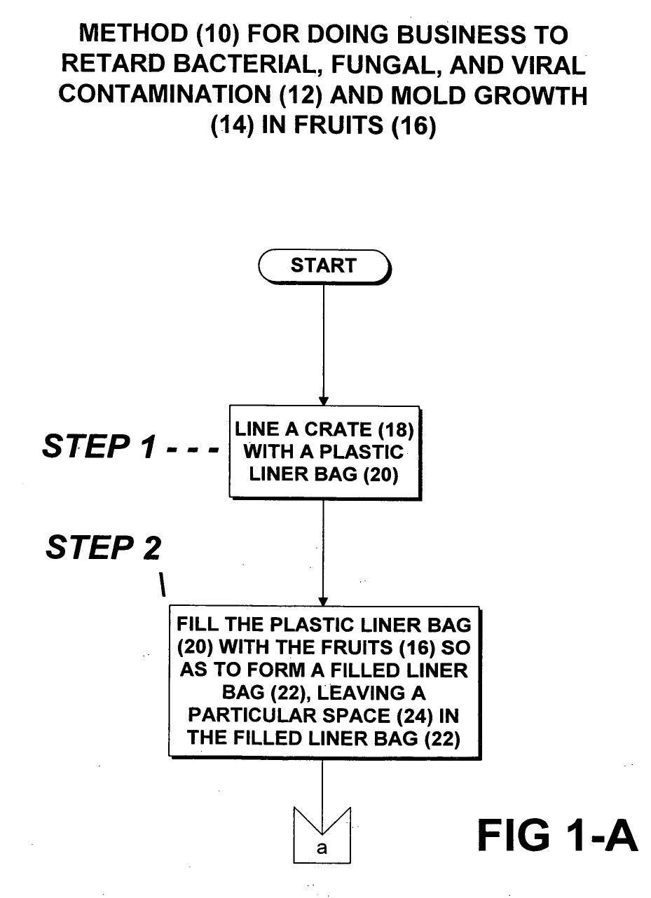

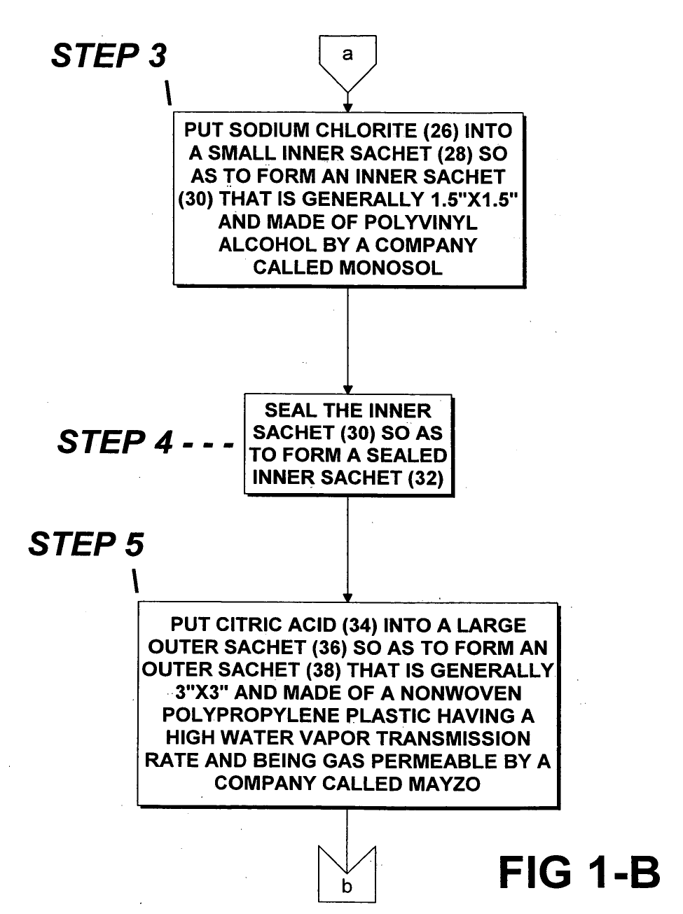

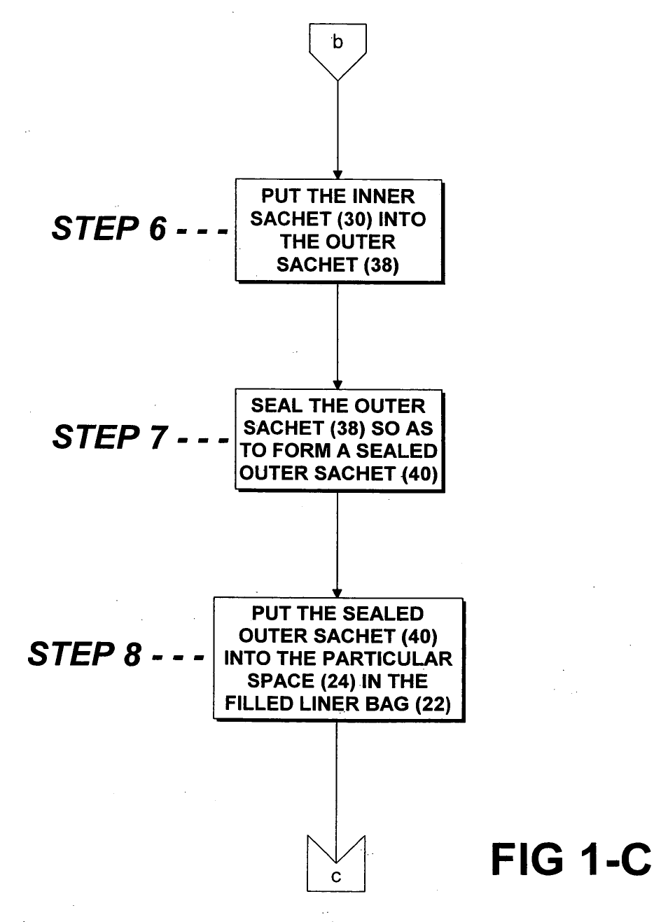

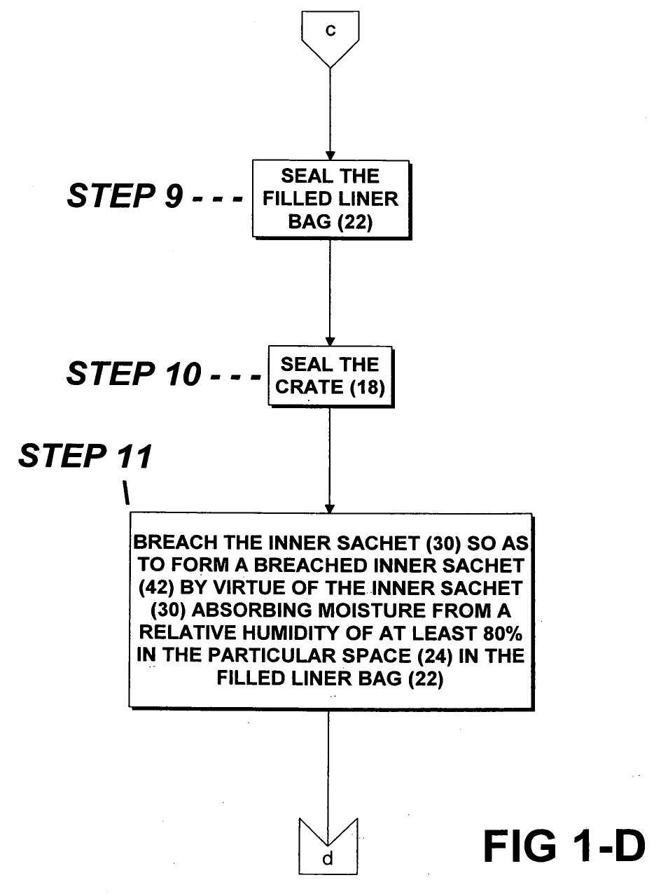

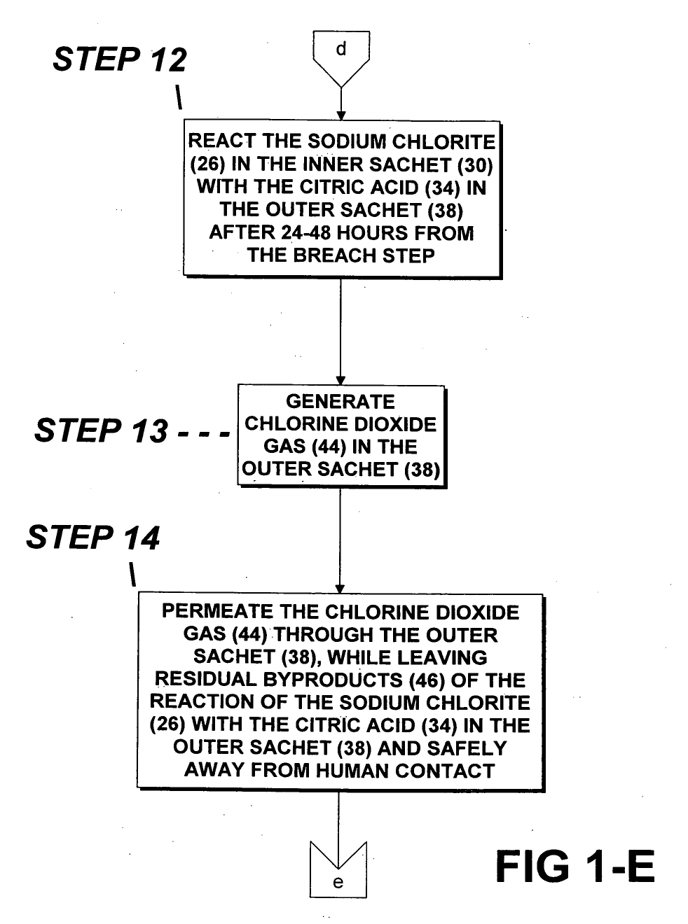

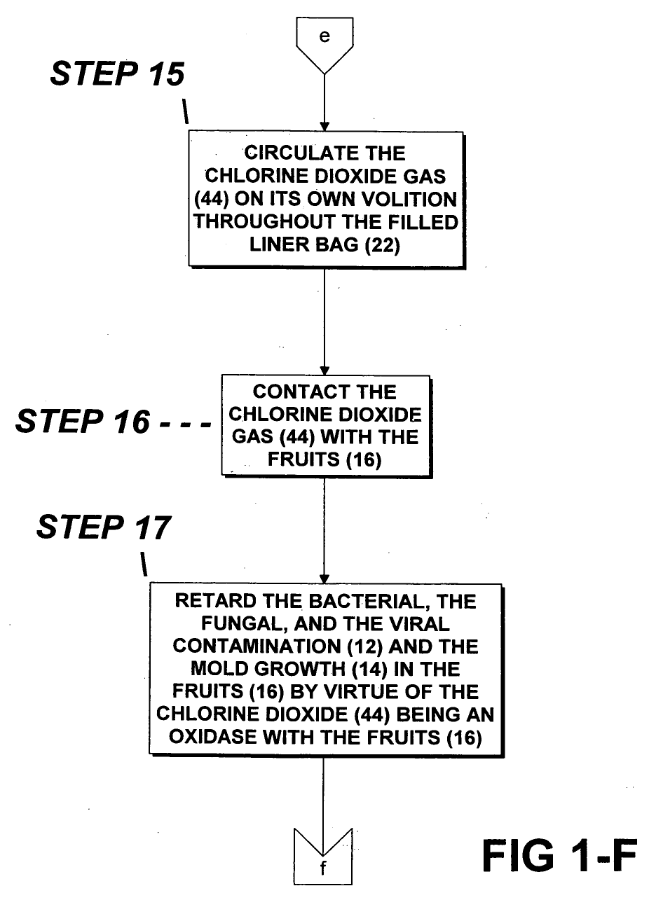

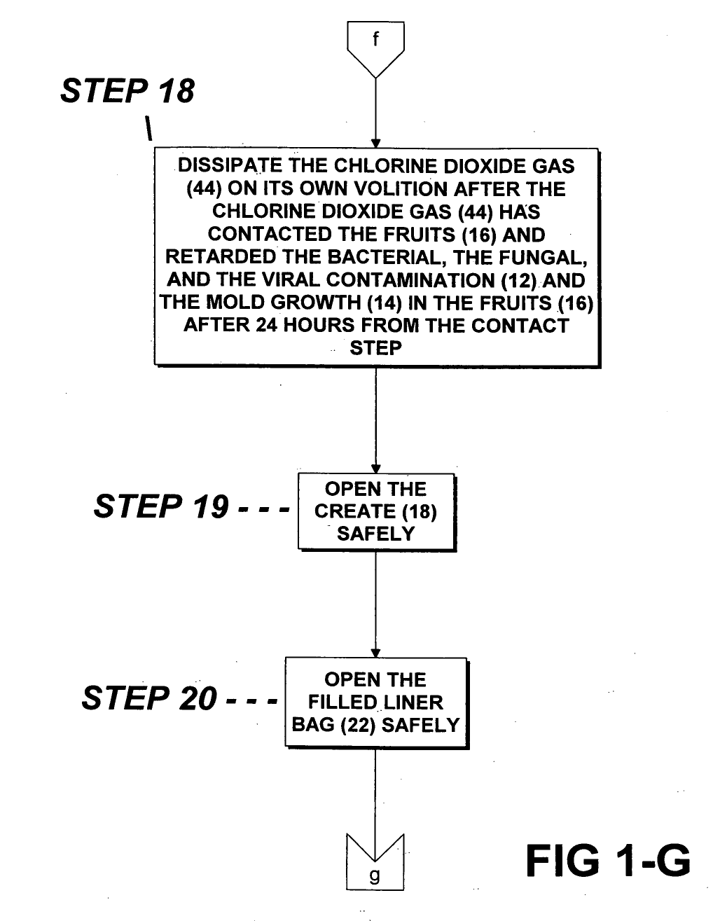

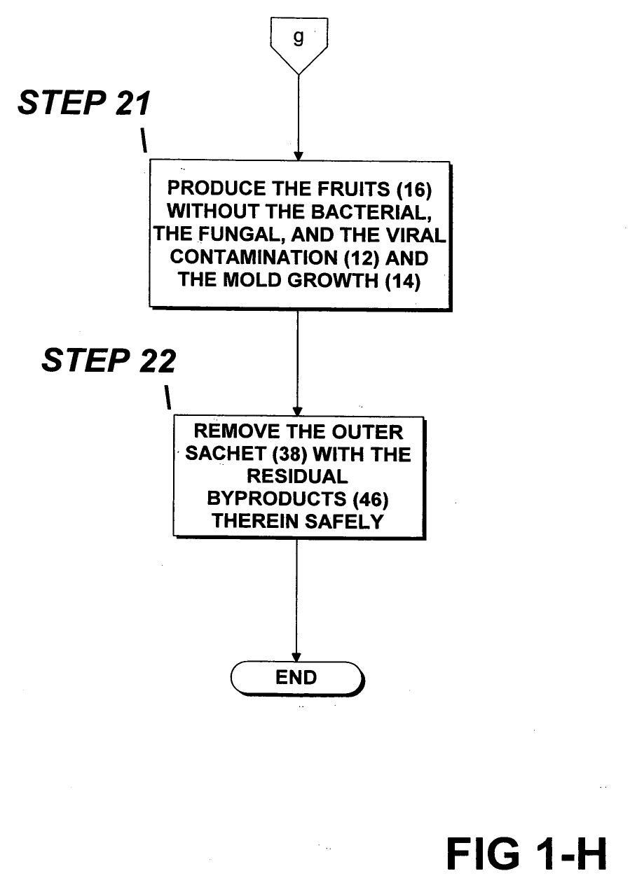

Referring now to the figures, in which like numerals indicate like parts, and particularly to FIGS. 1A-1H, which are a flowchart of the method of the embodiments of the present invention for doing business to retard bacterial, fungal, and viral contamination and mold growth in fruits, the method of the embodiments of the present invention is shown generally at 10 for doing business to retard bacterial, fungal, and viral contamination 12 and mold growth 14 in fruits 16.

### B. The Method 10 for Doing Business to Retard Bacterial, Fungal, and Viral Contamination 12 and Mold Growth 14 in Fruits 16.

The method 10 for doing business to retard bacterial, fungal, and viral contamination 12 and mold growth 14 in fruits 16, comprises the steps of:
STEP 1: Line a crate 18 with a plastic liner bag 20.
STEP 2: Fill the plastic liner bag 20 with the fruits 16 so as to form a filled liner bag 22, leaving a particular space 24 in the filled liner bag 22.
STEP 3: Put sodium chlorite 26 into a small inner sachet 28 so as to form an inner sachet 30 that is generally 1.5″×1.5″ and made of polyvinyl alcohol by a company called Monosol.
STEP 4: Seal the inner sachet 30 so as to form a sealed inner sachet 32.
STEP 5: Put citric acid 34 into a large outer sachet 36 so as to form an outer sachet 38 that is generally 3″×3″ and made of a nonwoven polypropylene plastic having a high water vapor transmission rate and being gas permeable by a company called Mayzo.
STEP 6: Put the inner sachet 30 into the outer sachet 38.
STEP 7: Seal the outer sachet 38 so as to form a sealed outer sachet 40.
STEP 8: Put the sealed outer sachet 40 into the particular space 24 in the filled liner bag 22.
STEP 9: Seal the filled liner bag 22.
STEP 10: Seal the crate 18.
STEP 11: Breach the inner sachet 30 so as to form a breached inner sachet 42 by virtue of the inner sachet 30 absorbing moisture from a relative humidity of at least 80% in the particular space 24 in the filled liner bag 22.
STEP 12: React the sodium chlorite 26 in the inner sachet 30 with the citric acid 34 in the outer sachet 38 after 24-48 hours from the breach step.
STEP 13: Generate chlorine dioxide gas 44 in the outer sachet 38.
STEP 14: Permeate the chlorine dioxide gas 44 through the outer sachet 38, while leaving residual byproducts 46 of the reaction of the sodium chlorite 26 with the citric acid 34 in the outer sachet 38 and safely away from human contact.
STEP 15: Circulate the chlorine dioxide gas 44 on its own volition throughout the filled liner bag 22.
STEP 16: Contact the chlorine dioxide gas 44 with the fruits 16.
STEP 17: Retard the bacterial, the fungal, and the viral contamination 12 and the mold growth 14 in the fruits 16 by virtue of the chlorine dioxide gas 44 being an oxidase with the fruits 16.
STEP 18: Dissipate the chlorine dioxide gas 44 on its own volition after the chlorine dioxide gas 44 has contacted the fruits 16 and retarded the bacterial, the fungal, and the viral contamination 12 and the mold growth 14 in the fruits 16 after 24 hours from the contact step.
STEP 19: Open the create 18 safely.
STEP 20: Open the filled liner bag 22 safely.
STEP 21: Produce the fruits 16 without the bacterial, the fungal, and the viral contamination 12 and the mold growth 14.
STEP 22: Remove the outer sachet 38 with the residual byproducts 46 therein safely.

### C. Conclusions.

It will be understood that each of the elements described above or two or more together may also find a useful application in other types of constructions differing from the types described above.

While the embodiments of the present invention have been illustrated and described as embodied in a method for doing business to retard bacterial, fungal, and viral contamination and mold growth in fruits, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A method for doing business to retard bacterial, fungal, and viral contamination and mold growth in fruits, comprising the steps of:
a) filling a plastic liner bag with the fruits so as to form a filled liner bag, leaving a particular space in the filled liner bag;
b) putting an anti-bacterial, fungal, and viral contamination and mold growth gas generating apparatus into the particular space in the filled liner bag;
c) sealing the filled liner bag;
d) generating an anti-bacterial, fungal, and viral contamination and mold growth gas by the anti-bacterial, fungal, and viral contamination and mold growth gas generating apparatus;
e) circulating the anti-bacterial, fungal, and viral contamination and mold growth gas on its own volition throughout the filled liner bag;
f) contacting the anti-bacterial, fungal, and viral contamination and mold growth gas with the fruits;
g) retarding the bacterial, the fungal, and the viral contamination and the mold growth in the fruits;
h) dissipating the anti-bacterial, fungal, and viral contamination and mold growth gas on its own volition after the anti-bacterial, fungal, and viral contamination and mold growth gas has contacted the fruits and retarded the bacterial, the fungal, and the viral contamination and the mold growth in the fruits;
i) producing the fruits without the bacterial, the fungal, and the viral contamination and the mold growth; and
j) removing the anti-bacterial, fungal, and viral contamination and mold growth gas generating apparatus with residual byproducts therein safely.

2. The method of claim 1, wherein said putting step includes putting sodium chlorite into a small inner sachet so as to form an inner sachet.

3. The method of claim 2, wherein said putting step further includes putting the sodium chlorite into a small inner sachet so as to form an inner sachet that is generally 1.5″×1.5″ and made of polyvinyl alcohol.

4. The method of claim 3, further comprising the step of sealing the inner sachet so as to form a sealed inner sachet.

5. The method of claim 4, wherein said putting step further includes putting citric acid into a large outer sachet so as to form an outer sachet.

6. The method of claim 5, wherein said putting step further includes putting citric acid into a large outer sachet so as to form an outer sachet that is generally 3″×3″ and made of a nonwoven polypropylene plastic having a high water vapor transmission rate and being gas permeable.

7. The method of claim 6, wherein said putting step further includes putting the inner sachet into the outer sachet.

8. The method of claim 7, wherein said putting step further includes sealing the outer sachet so as to form a sealed outer sachet.

9. The method of claim 8, wherein said putting step further includes putting the sealed outer sachet into the particular space in the filled liner bag.

10. The method of claim 9, wherein said generating step includes breaching the inner sachet so as to form a breached inner sachet by virtue of the inner sachet absorbing moisture from a relative humidity of at least 80% in the particular space in the filled liner bag.

11. The method of claim 10, wherein said generating step further includes reacting the sodium chlorite in the inner sachet with the citric acid in the outer sachet.

12. The method of claim 11, wherein said generating step further includes generating chlorine dioxide gas as the anti-bacterial, fungal, and viral contamination and mold growth gas in the outer sachet.

13. The method of claim 12, wherein said generating step further includes permeating the chlorine dioxide gas through the outer sachet, while leaving residual byproducts of the reaction of the sodium chlorite with the citric acid in the outer sachet and safely away from human contact.

14. The method of claim 13, wherein said circulating step includes circulating the chlorine dioxide gas on its own volition throughout the filled liner bag.

15. The method of claim 14, wherein said contacting step includes contacting the chlorine dioxide gas with the fruits.

16. The method of claim 15, wherein said retarding step includes retarding the bacterial, the fungal, and the viral contamination and the mold growth in the fruits by virtue of the chlorine dioxide gas being an oxidase with the fruits.

17. The method of claim 16, wherein said dissipating step includes dissipating the chlorine dioxide gas on its own volition after the chlorine dioxide gas has contacted the fruits and retarded the bacterial, the fungal, and the viral contamination and the mold growth in the fruits.

18. The method of claim 17, further comprising the step of lining a crate with the plastic liner bag.

19. The method of claim 18, wherein said reacting step includes reacting the sodium chlorite in the inner sachet with the citric acid in the outer sachet after 24-48 hours from the breaching step.

20. The method of claim 19, wherein said dissipating step includes dissipating the chlorine dioxide gas 24 hours after the chlorine dioxide gas has contacted the fruits and retarded the bacterial, the fungal, and the viral contamination and the mold growth in the fruits.
